(19) United States
(12) Patent Application Publication
(10) Pub. No.: US 2021/0047763 A1
(43) Pub. Date: Feb. 18, 2021

(54) BONDING MATERIAL AND METHOD FOR MANUFACTURING THE SAME AND FIBER MOLDED ARTICLE AND METHOD FOR MANUFACTURING THE SAME

(71) Applicant: SEIKO EPSON CORPORATION, Tokyo (JP)

(72) Inventors: Masahiko NAKAZAWA, Matsumoto (JP); Yoshihiro UENO, Shiojiri (JP)

(21) Appl. No.: 16/989,938

(22) Filed: Aug. 11, 2020

(30) Foreign Application Priority Data
Aug. 13, 2019 (JP) 2019-148464

(51) Int. Cl. D04H 1/60; D04H 1/587; B29B 7/82; B29B 9/16; D04H 1/425; C09J 167/00

(52) U.S. Cl. CPC D04H 1/60; D04H 1/587; C09J 167/00; B29B 9/16; D04H 1/425; B29B 7/82

(57) ABSTRACT

A bonding material for fiber binding includes a resin composition containing an amorphous thermoplastic resin and a crystalline thermoplastic resin, where the bonding material has a melting temperature lower than the melting temperature of the crystalline thermoplastic resin and a softening temperature higher than the softening temperature of the amorphous thermoplastic resin.

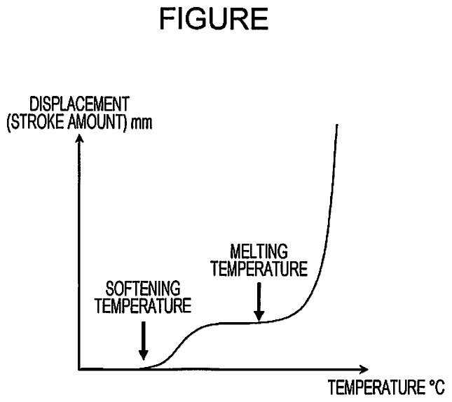

The present application is based on, and claims priority from JP Application Serial Number 2019-148464, filed Aug. 13, 2019, the disclosure of which is hereby incorporated by reference herein in its entirety.

### BACKGROUND

### 1. Technical Field

The present disclosure relates to a bonding material and a method for manufacturing a bonding material and to a fiber molded article and a method for manufacturing a fiber molded article.

### 2. Related Art

As a method for manufacturing fiber molded articles such as paper, expectations have been attached to a method called a “dry method” in which little or no water is used. For example, JP-A-2015-092032 discloses a technique in which a fiber and a thermoplastic resin are mixed through the dry method and heat is applied to the mixture, the mixture being accumulated in the form of a sheet, to thereby manufacture paper.

### SUMMARY

In general, a sheet containing a thermoplastic resin serving as a bonding material that binds fibers may curl or wrinkle in high-temperature environments. For example, when inserted between heat rollers or the like, the sheet may wrap around the rollers, thereby resulting in unstable sheet transportation by the rollers. Given that such a phenomenon is conceived to relate to an interrelated combination of the environmental temperature with the softening temperature and the melting temperature of the bonding material, it is difficult to avoid the occurrence of such a phenomenon merely by selecting a resin serving as a bonding material as in the technique disclosed in JP-A-2015-092032.

That is, there has been a desire for a bonding material configured to provide a fiber molded article that well maintains the mechanical properties of the fiber molded article and that excels in form stability in high-temperature environments, the fiber molded article containing fibers and the bonding material, where the plurality of fibers are bound by the bonding material.

A bonding material for fiber binding according to an aspect of the present disclosure includes
a resin composition containing
   an amorphous thermoplastic resin and
   a crystalline thermoplastic resin, wherein the bonding material has
   a melting temperature lower than a melting temperature of the crystalline thermoplastic resin and
   a softening temperature higher than a softening temperature of the amorphous thermoplastic resin.

In the bonding material according to the foregoing aspect,
the bonding material may be a powder, and
a content of the crystalline thermoplastic resin with respect to a total amount of the resin composition may be 10% by mass or more and 30% by mass or less.

A fiber molded article according to an aspect of the present disclosure contains
the bonding material for fiber binding according to the first-mentioned aspect and
a plurality of fibers, wherein
the plurality of fibers are bound by the bonding material.

A method for manufacturing a bonding material for fiber binding according to an aspect of the present disclosure includes
a kneading step of performing melt-kneading of an amorphous thermoplastic resin and a crystalline thermoplastic resin to form a resin composition,
a pelletizing step of pelletizing the resin composition, and
a pulverizing step of pulverizing the resin composition pelletized.

In the method for manufacturing a bonding material according to the foregoing aspect,
in the kneading step, the melt-kneading may be performed such that a content of the crystalline thermoplastic resin with respect to a total amount of the resin composition is 10% by mass or more and 30% by mass or less.

A method for manufacturing a fiber molded article according to an aspect of the present disclosure includes
a mixing step of mixing the bonding material for fiber binding according to the first-mentioned aspect and a fiber, an accumulating step of accumulating the fiber and the bonding material in a mixture, and
a binding step of binding the fiber and the bonding material in the mixture, the fiber and the bonding material in the mixture being an accumulation accumulated.

### BRIEF DESCRIPTION OF THE DRAWING

The FIGURE is a graph representing the softening temperature and the melting temperature, for which the bonding material of each example was measured with a flow tester.

### DESCRIPTION OF EXEMPLARY EMBODIMENTS

Hereafter, several embodiments of the present disclosure will be described. The embodiments described below are intended to describe examples of the present disclosure. The present disclosure is not limited to the embodiments below and includes various modified embodiments implemented within the scope that does not depart from the spirit of the present disclosure. Not all the structures described below are necessarily the essential structures for the present disclosure.

### 1. BONDING MATERIAL

A bonding material according to the present embodiment includes a resin composition containing an amorphous thermoplastic resin and a crystalline thermoplastic resin.

### 1.1 Resin Composition

The resin composition included in the bonding material contains an amorphous thermoplastic resin and a crystalline thermoplastic resin.

### 1.1.1. Amorphous Thermoplastic Resin

The amorphous thermoplastic resin is non-crystalline. The amorphous thermoplastic resin, for example, exhibits no behavior corresponding to crystal melting or crystal formation when the thermophysical properties of the resin are observed. Furthermore, the amorphous thermoplastic resin exhibits no characteristics attributed to a crystalline phase but does exhibit characteristics corresponding to an amorphous phase when, for example, X-ray structural analysis is performed.

The amorphous thermoplastic resin is plasticized and melted by heating. The amorphous thermoplastic resin has fluidity when the temperature thereof is increased. The amorphous thermoplastic resin has no melting point attributed to crystal melting, but does have a glass transition point (glass transition temperature: Tg) attributed to molecular motion in the amorphous portion of the resin. At a temperature lower than the glass transition temperature, the amorphous thermoplastic resin is in a glassy state and poor in flexibility and fluidity. At a temperature higher than the glass transition temperature, the amorphous thermoplastic resin is brought to a rubbery state and exhibits flexibility. As the temperature is increased from there, the amorphous thermoplastic resin exhibits fluidity.

Examples of the amorphous thermoplastic resin include polyvinyl chloride, polystyrene, poly(meth)acrylic acid methyl, acrylonitrile-butadiene-styrene resins, polycarbonate, modified polyphenylene ether, polyethersulfone, polyetherimide, and polyamide-imide. The amorphous thermoplastic resin may be copolymerized or modified, and, for example, styrene resins, acrylic resins, styrene-acrylic copolymer resins, olefin resins, vinyl chloride resins, polyester resins, polyamide resins, polyurethane resins, polyvinyl alcohol resins, vinyl ether resins, N-vinyl resins, and styrene-butadiene resins that are caused to be amorphous through copolymerization or modification may be used.

As the amorphous thermoplastic resin, an amorphous thermoplastic resin compatible with the crystalline thermoplastic resin is selected. Plural kinds of amorphous thermoplastic resins may be used, in which case at least one kind selected is an amorphous thermoplastic resin compatible with at least one kind of the crystalline thermoplastic resins described later.

The amorphous thermoplastic resin is particularly preferably a polyester resin modified or copolymerized to be amorphous in view of, for example, good affinity and good binding with the fiber described later.

The content of the amorphous thermoplastic resin with respect to the total amount of the resin composition is not particularly limited, but, for example, is 40% by mass or more and 98% by mass or less, preferably 50% by mass or more and 95% by mass or less, and more preferably 70% by mass or more and 90% by mass or less.

The Tg of the amorphous thermoplastic resin is not particularly limited, but the amorphous thermoplastic resin is, preferably, brought to a glassy state at room temperature and brought to a rubbery state at a temperature around which the fiber described later remains undamaged. The Tg of the amorphous thermoplastic resin is, for example, 25° C. or more and 150° C. or less, preferably 30° C. or more and 120° C. or less, and more preferably 40° C. or more and 100° C. or less. The Tg of the amorphous thermoplastic resin is measurable through, for example, differential scanning calorimetry (DSC).

As the amorphous thermoplastic resin, an amorphous thermoplastic resin compatible with the crystalline thermoplastic resin is selected, and when compatibilized therewith, the amorphous thermoplastic resin has a Tg higher than before compatibilization or the Tg becomes difficult to observe.

### 1.1.2. Crystalline Thermoplastic Resin

The crystalline thermoplastic resin is crystalline. The crystalline thermoplastic resin, for example, exhibits behavior corresponding to crystal melting and crystal formation when the thermophysical properties of the resin are observed. Furthermore, the crystalline thermoplastic resin exhibits characteristics attributed to a crystalline phase when, for example, X-ray structural analysis is performed. The crystalline thermoplastic resin is not entirely crystallized but has a predetermined degree of crystallinity. The degree of crystallinity of the crystalline thermoplastic resin is not particularly limited.

The crystalline thermoplastic resin may have a so-called supercooled state, and, for example, when cooled from a temperature higher than the crystal melting point, the resin may be unable to be crystallized depending on the cooling speed. However, in this specification, “crystalline thermoplastic resin” refers to a resin that forms crystals when cooled under conditions suitable for crystallization.

The crystalline thermoplastic resin is plasticized and melted by heating. The crystalline thermoplastic resin has fluidity when the temperature thereof is increased. The crystalline thermoplastic resin has a melting point attributed to crystal melting. At or above the melting point, the crystalline thermoplastic resin is melted and exhibits fluidity.

Furthermore, the crystalline thermoplastic resin has crystalline and amorphous portions at a temperature lower than the crystal melting point. Thus, although the amorphous portion of the crystalline thermoplastic resin has thermophysical properties corresponding to Tg, the physical properties of the crystalline thermoplastic resin, such as flexibility and fluidity, depend more largely on the melting point of the crystalline portion than on the Tg of the amorphous portion; therefore, when it comes to the crystalline thermoplastic resin contained in the resin composition according to the present embodiment, the focus is on the melting point or properties related to the melting point.

Examples of the crystalline thermoplastic resin include polyethylene, polypropylene, polyamide, polyacetal, polyethylene terephthalate, polybutylene terephthalate, polyethylene succinate, polybutylene succinate, polyhydroxybutyrate, polylactic acid, polyphenylene sulfide, and polyether ether ketone. The crystalline thermoplastic resin may be copolymerized or modified, and, even when copolymerized or modified, the resin is crystalline. For example, polyester resins, polyamide resins, and polyurethane resins that are crystalline may be used.

As the crystalline thermoplastic resin, a crystalline thermoplastic resin compatible with the above-described amorphous thermoplastic resin is selected. Plural kinds of crystalline thermoplastic resins may be used, in which case at least one kind selected is a crystalline thermoplastic resin compatible with at least one kind of the above-described amorphous thermoplastic resins.

The crystalline thermoplastic resin is particularly preferably a polyester resin modified or copolymerized to be crystalline in view of, for example, good affinity and good binding with the fiber described later. With the crystalline thermoplastic resin and the amorphous thermoplastic resin both selected from modified or unmodified polyester resins, the compatibility between both resins is easily achieved.

The content of the crystalline thermoplastic resin with respect to the total amount of the resin composition is not particularly limited, but, for example, is 2% by mass or more and 60% by mass or less, preferably 5% by mass or more and 50% by mass or less, and more preferably 10% by mass or more and 30% by mass or less.

The melting point of the crystalline portion of the crystalline thermoplastic resin is not particularly limited, but is, preferably, a temperature higher than room temperature, the temperature being a temperature around or below the temperature at which the fiber described later remains undamaged. The melting point of the crystalline portion of the crystalline thermoplastic resin is, for example, 50° C. or more and 120° C. or less, preferably 70° C. or more and 110° C. or less, and more preferably 80° C. or more and 110° C. or less. The melting point of the crystalline thermoplastic resin is measurable through, for example, differential scanning calorimetry (DSC).

As the crystalline thermoplastic resin, a crystalline thermoplastic resin compatible with the amorphous thermoplastic resin is selected, and when compatibilized therewith, the crystalline thermoplastic resin has a melting point lower than before compatibilization or the melting point disappears.

### 1.1.3. Other Components

The resin composition may contain components other than described above. Examples of such components include compatibilizers, colorants, aggregation inhibitors, ultraviolet absorbers, flame retardant materials, antistatic agents, static control agents, organic solvents, surfactants, antifungal agents, antiseptic agents, antioxidants, and oxygen absorbers. These components may be mixed, as a component of the bonding material, in a form separate from particles of the resin composition.

1.2. Relationship between Melting Temperature and Softening Temperature

The bonding material including the above-described resin composition has a melting temperature and a softening temperature.

In this specification, “softening temperature”, which is a temperature measured with a flow tester, refers mainly to a temperature related to the Tg of the thermoplastic resins. The softening temperature is close to the Tg of the thermoplastic resins, but is not the Tg per se. The softening temperature is a value resulting from the combined effects of many conditions and measured with a flow tester. The softening temperature corresponds to the temperature at which the thermoplastic resins soften during the temperature increase process.

Further details of the method for measuring the softening temperature are now described.

Into a cylinder (cylinder having an inner diameter of 20 mm) of a flow tester, 3 g of the thermoplastic resins included in the bonding material are filled. A piston is inserted into the cylinder to thereby press pellets of the foregoing in the cylinder at a load of 20 N. An orifice having a hole diameter of 2 mm and a hole length of 8 mm is located at the tip of the cylinder in the pressing direction of the piston. The temperature is increased in this state, and a plot where the horizontal axis corresponds to the temperature and the vertical axis corresponds to the cylinder stroke is created. The temperature at which the piston starts to move is read off from the resulting plot and this temperature is determined to be the softening temperature. A graph of the differential of the plot may be used to read off the softening temperature. Thus, “softening temperature” can also be referred to as the temperature at which, at a predetermined load, the pellets start to deform during the temperature increase process.

In this specification, “melting temperature”, which is a temperature measured with a flow tester, refers mainly to a temperature related to the temperature at which the above-described amorphous thermoplastic resin exhibits fluidity and to the melting point of the above-described crystalline thermoplastic resin. The melting temperature is close to the melting point of the crystalline thermoplastic resin, but is not the melting point per se. The melting temperature is a value resulting from the combined effects of many conditions and measured with a flow tester. The melting temperature corresponds to the temperature at which the thermoplastic resins start to flow during the temperature increase process.

Further details of the method for measuring the melting temperature are now described.

In the same manner as with the above-described softening temperature, a plot where the horizontal axis corresponds to the temperature and the vertical axis corresponds to the cylinder stroke is created. In the resulting plot, when a region where the stroke is constant is present after the softening temperature is reached, the melting temperature is determined to be a temperature at which the stroke amount starts to increase thereafter, and when a region where the stroke is constant is absent after the softening temperature is reached, the melting temperature is determined to be a temperature equal to the softening temperature and this temperature is determined to be the melting temperature. A graph of the differential of the plot may be used to read off the melting temperature. Thus, “melting temperature” can also be referred to as the temperature at which, at a predetermined load, the pellets are melted and start to flow inside the orifice hole during the temperature increase process.

In general, even when two kinds of thermoplastic resins are melt-kneaded, a resin composition having a phase separation structure is obtained. Thus, neither the Tg nor the melting point of one of the resins is susceptible to the effects of the other resin and it is difficult to change physical property values, such as the foregoing, of these resins. On the other hand, because the resin composition included in the bonding material according to the present embodiment contains two kinds of thermoplastic resins having compatibility with each other, the Tg or the melting point of one of the resins is changed due to the effects of the other resin.

The bonding material according to the present embodiment has a melting temperature lower than the melting temperature of the above-described crystalline thermoplastic resin. Furthermore, the bonding material according to the present embodiment has a softening temperature higher than the softening temperature of the amorphous thermoplastic resin. The conceivable reasons therefor are as follows.

The conceivable reason for the increase in the softening temperature is that, as a result of crystalline molecules being present in amorphous polymer chains, reciprocal changes occur in the steric configuration of the molecular chains involved, thereby contributing to increased intermolecular forces. The conceivable reason for the decrease in the melting temperature is that amorphous molecular chains, being originally present in the crystalline resin, make the resin less crystalline, thereby contributing to a lower melting point. Thus, the bonding material according to the present embodiment has properties of having the softening temperature and the melting temperature close to each other. The temperature difference between the softening temperature and the melting temperature is, for example, within 50° C., preferably within 30° C., more preferably within 10° C., and even more preferably within 5° C., and, particularly preferably, the softening temperature and the melting temperature match.

### 1.3. Properties of Bonding Material

The bonding material according to the present embodiment can have powder properties. When the bonding material is a powder, the particle diameter (volume-based average particle diameter) of particles of the bonding material is preferably 50 μm or less, more preferably 30 μm or less, even more preferably 25 μm or less, and particularly preferably 20 μm or less. When the average particle diameter is small, during the formation of the fiber structure described later, the gravity applied to the bonding material is decreased, which can prevent or reduce the detachment of the bonding material from between fibers that is caused by the empty weight of the bonding material. When the bonding material is in the above-described particle diameter range, the detachment of the bonding material from fibers sufficiently hardly occurs, which enables binding of fibers.

### 1.4. Method for Manufacturing Bonding Material

A method for manufacturing a bonding material according to the present embodiment includes a kneading step of performing melt-kneading of an amorphous thermoplastic resin and a crystalline thermoplastic resin to form a resin composition, a pelletizing step of pelletizing the resin composition, and a pulverizing step of pulverizing the resin composition pelletized.

The resin composition is formed by melt-kneading an amorphous thermoplastic resin and a crystalline thermoplastic resin. The crystalline thermoplastic resin and the amorphous thermoplastic resin may both be obtained and synthesized in all forms. The resin composition can be formed by melt-kneading the amorphous thermoplastic resin and the crystalline thermoplastic resin. In this kneading step, the content of the crystalline thermoplastic resin and the amorphous thermoplastic resin with respect to the total amount of the resin composition can be adjusted, and, for example, melt-kneading may be performed such that the content of the crystalline thermoplastic resin with respect to the total amount of the resin composition is 10% by mass or more and 30% by mass or less.

By melt-kneading the amorphous thermoplastic resin and the crystalline thermoplastic resin, a resin composition in which both resins are compatibilized is obtainable. The melt-kneading temperature can be appropriately set by adjusting, for example, the melting temperature of the thermoplastic resins and conditions for an apparatus used for melt-kneading. The resin composition formed through melt-kneading may be pulverized as it is to form the bonding material or, after extrusion molding, may be subjected to the pelletizing step to form the bonding material. As a result of the resin composition being formed through melt-kneading, being pelletized, and then being pulverized, the bonding material is obtainable in a state of a powder having a predetermined particle diameter.

Melt-kneading can be performed with, for example, a kneader, a Banbury mixer, a single-screw extruder, a multi-screw extruder, a double-roll kneader, a triple-roll kneader, a continuous kneader, or a continuous double-roll kneader. Pulverization can be performed with a pulverizing machine such as a hammer mill, a pin mill, a cutter mill, a pulverizer, a turbo mill, a disc mill, a screen mill, or a jet mill. With an appropriate combination of these, a powder of the bonding material is obtainable.

The pulverizing step may be performed on a stage-by-stage basis, for example, through starting with rough pulverization to achieve an approximate particle diameter of about 1 mm, followed by fine pulverization to achieve the target particle diameter. Even in such a case, the apparatuses exemplified can be appropriately utilized at each stage. To further improve the efficiency of pulverizing the resin composition, a freeze-grinding method can be used. A powder of the resin composition thus obtained can be formed into the bonding material, but the bonding material may contain particles of various particle diameters. Thus, as needed, particle classification may be performed with a publicly known classifier.

The volume average particle diameter of particles of the bonding material is measurable with, for example, a particle size distribution analyzer whose measurement principle is a laser diffraction and scattering method. An example of the particle size distribution analyzer is a particle size distribution meter whose measurement principle is a dynamic light scattering method (e.g., “Microtrac UPA”, manufactured by Nikkiso Co., Ltd.).

### 2. FIBER MOLDED ARTICLE AND METHOD FOR MANUFACTURING THE SAME

A fiber molded article according to the present embodiment contains the above-described bonding material for fiber binding and a plurality of fibers, where the plurality of fibers are bound by the bonding material. Here, “fiber molded article” refers mainly to a fiber molded article formed into a sheet. However, the fiber molded article is not limited to a fiber molded article in the form of a sheet and may have a board form, a web form, or a form having irregularities. Examples of the typical fiber molded article in this specification include paper and a non-woven fabric. Examples of the paper include aspects obtained by molding pulp or waste paper serving a raw material into a sheet, and these include recording paper for writing and printing, wallpaper, wrapping paper, colored paper, drawing paper, and Kent paper. The non-woven fabric is thicker than the paper or has a strength lower than the strength of the paper, and examples of the non-woven fabric include ordinary non-woven fabrics, fiber boards, tissue paper, paper towels, cleaners, filters, liquid absorbing materials, sound absorbers, cushioning materials, and mats.

### 2.1. Fiber

The fiber contained in the fiber molded article according to the present embodiment is not particularly limited, and a wide range of fiber materials can be used. Examples of the fiber include natural fibers (animal fibers and plant fibers) and chemical fibers (organic fibers, inorganic fibers, and organic-inorganic composite fibers). More specific examples include fibers of cellulose, silk, wool, cotton, hemp, kenaf, flax, ramie, jute, Manila hemp, Sisal hemp, a conifer, a broad-leaved tree, and the like. These may be used alone, in an appropriate mixture, or in the form of recycled fibers treated with, for example, refinement.

Examples of the raw material of the fiber include waste paper and waste fabrics, and these contain at least one kind of these fibers. Furthermore, the fiber may have various kinds of surface treatment applied thereto. The substance of the fiber may be a pure substance or a substance containing a plurality of components such as impurities, additives, and other components.

Individual fibers formed from the fiber have an average diameter (when a section thereof is not a circle, the maximum length in the direction perpendicular to the longitudinal direction or, when a circle having an area as large as the area of the section is hypothesized, the diameter of the circle (i.e., circle equivalent diameter)) of, on average, 1 μm or more and 1000 μm or less, preferably 2 μm or more and 500 μm or less, and more preferably 3 μm or more and 200 μm or less.

The length of the fiber is not particularly limited, but the length of individual fibers formed from the fiber in the longitudinal direction is 1 μm or more and 5 mm or less, preferably 2 μm or more and 3 mm or less, and more preferably 3 μm or more and 2 mm or less.

The bonding material contained in the fiber molded article is the above-described bonding material for fiber binding and contains a crystalline thermoplastic resin and an amorphous thermoplastic resin. Whether or not such a bonding material is contained can be confirmed through, for example, IR (infrared spectroscopy), NMR (nuclear magnetic resonance), MS (mass spectrometry), or various kinds of chromatography.

### 2.2. Method for Manufacturing Fiber Molded Article

A method for manufacturing a fiber molded article according to the present embodiment includes a mixing step of mixing the above-described bonding material for fiber binding and a fiber, an accumulating step of accumulating the fiber and the bonding material in a mixture, and a binding step of binding the fiber and the bonding material in the mixture, the fiber and the bonding material in the mixture being an accumulation accumulated.

The mixing step can be performed, for example, by mixing the fiber and the bonding material in air. The accumulating step can be performed by, in air, pouring the mixture mixed during the mixing step to thereby accumulate the mixture onto, for example, a mesh. The binding step can be performed by heating the accumulation obtained during the accumulating step with, for example, a heat press or a heat roller to thereby melt the bonding material.

The method for manufacturing a fiber molded article according to the present embodiment may include, as needed, at least one step selected from the group consisting of cutting, for example, a pulp sheet or waste paper serving as a raw material in air, a defibrating step of breaking the raw material down into the form of fibers in air, a classifying step of classifying, in air, impurities and fibers shortened through defibration from the defibrated material defibrated, a separating step of separating, in air, long fibers (filament fibers) and undefibrated pieces that are insufficiently defibrated from the defibrated material, a pressurizing step of pressurizing at least one of the accumulation and the fiber molded article, a cutting step of cutting the fiber molded article, and a wrapping step of wrapping the fiber molded article.

In the fiber molded article, the ratio at which the above-described fiber and the bonding material are mixed can be appropriately adjusted according to, for example, the strength and the use of the fiber molded article to be manufactured. When the fiber molded article is for office use in, for example, copy paper, the percentage of the bonding material with respect to the fiber is 5% by mass or more and 70% by mass or less.

### 3. EXAMPLES AND COMPARATIVE EXAMPLES

Hereafter, Examples and Comparative Examples are provided to further describe the present disclosure, but the examples below are not intended to limit the present disclosure.

### 3.1. Manufacture of Bonding Material

As an amorphous thermoplastic resin, an ACT-2201 (manufactured by DIC Corporation) was used. As a crystalline thermoplastic resin, a Bionolle (manufactured by Showa Highpolymer Co., Ltd.) was used. These were obtained in the form of pellets. Both resins were melt-kneaded at the mixing ratios (mass based) presented in Table 1 and were pelletized to obtain the resin composition of each example. The melt-kneading and pelletizing conditions are as described below. The pellets of Comparative Example 1 were pellets of only the amorphous thermoplastic resin, and the pellets of Comparative Example 3 were pellets of only the crystalline thermoplastic resin. The pellets of each example were used for evaluating the softening temperature and the melting temperature.

The resins mixed at the mixing ratio of each example were kneaded at a temperature of 150° C. with a small twin-screw kneader extruder (KZW15TW-45MG-NH, manufactured by Technovel Corporation) to thereby obtain the pellets of each example.

TABLE 1

| | | | | | High- |
|---|---|---|---|---|---|
| | | Softening | Melting | | temperature |
| | Mixing ratio | temperature | temperature | Paper | paper passage |
| | amorphous:crystalline | (° C.) | (° C.) | strength | performance |
| Example 1 | 9:1 | 75 | 75 | A | A |
| Example 2 | 8:2 | 80 | 80 | A | A |
| Example 3 | 7:3 | 105 | 105 | B | A |
| Comparative | 10:0 | 64 | 84 | B | C |
| Example 1 | | | | | |
| Comparative | 5:5 | 60 | 111 | C | C |
| Example 2 | | | | | |
| Comparative | 0:10 | 94 | 119 | C | A |
| Example 3 | | | | | |

### 3.2. Manufacture of Fiber Molded Article

The pellets of the resin composition obtained in each example were pulverized to form a powder of the resin composition having a volume average particle diameter of 20 μm. After weighing 22.5 g of bleached conifer kraft pulp and 7.5 g of the bonding material of each example, the bleached conifer kraft pulp and the bonding material were poured in this order into a clean polyethylene ointment jar (capacity: 1000 ml) and the jar was capped. The rotational speed of a ball mill rotating stand was adjusted such that the jar had a circumferential speed of 15 m/min when mounted on the ball mill rotating stand, and the ball mill rotating stand was rotated for 8 minutes for each example. The resulting mixture of each example was retrieved in a manner in which the exposure of the mixture to vibration or airflow was minimized to the extent possible. The mixture of each example was then heat pressed at a temperature of 150° C. and a pressure of 15 MPa for 30 seconds to melt the resins, and the resins were cooled. As a result, the fiber molded article of each example was obtained.

### 3.3. Evaluation of Softening Temperature and Melting Temperature

In each example, the softening temperature and the melting temperature with respect to the characteristics of the temperature (° C.) and displacement (stroke amount, mm) represented in the FIGURE were measured. Into a cylinder (cylinder having an inner diameter of 9.5 mm) of a flow tester, 3 g of the pellets of the bonding material of each example were filled. A piston was inserted into the cylinder to thereby press the pellets in the cylinder at a load of 20 N. An orifice having a hole diameter of 2 mm and a hole length of 8 mm was located at the tip of the cylinder in the pressing direction of the piston. The temperature was increased in this state, and a plot where the horizontal axis corresponded to the temperature and the vertical axis corresponded to the cylinder stroke was created. The temperature at which the piston started to move was read off from the resulting plot and this temperature was determined to be the softening temperature.

In the resulting plot, when a region where the stroke was constant was present after the softening temperature was reached, the melting temperature was determined to be a temperature at which the stroke amount started to increase thereafter, and when a region where the stroke was constant was absent after the softening temperature was reached, the melting temperature was determined to be a temperature equal to the softening temperature and this temperature was determined to be the melting temperature.

The softening temperature and the melting temperature read off in each example are presented side-by-side in Table 1.

### 3.4. Evaluation of Paper Strength

Sensory analysis was manually performed on the fiber molded article (paper) of each example with regard to folding, tearing, and cutting with scissors. As a result, with the fiber molded article (paper) of Comparative Example 1 being set as the standard “B”, cases better than this were evaluated as “A” and cases poorer than this were evaluated as “C”. The results are presented in Table 1.

### 3.5. Evaluation of High-Temperature Paper Passage Performance

The high-temperature paper passage performance was evaluated by passing 50 sheets of the fiber molded article (paper) of each example through a printer and identifying the presence or absence of a paper jam. The fiber molded article was confirmed to be heated to about 70° C. in the printer. The evaluation was made in accordance with the standards below. The results are presented in Table 1.
A: No sheet of paper was jammed.
C: One or more sheets of paper were jammed.

### 3.6. Evaluation Results

As revealed in Table 1, the fiber molded articles of all the Examples containing the bonding material for fiber binding described below excel in paper strength and high-temperature paper passage performance. The bonding material for fiber binding includes the resin composition containing the amorphous thermoplastic resin and the crystalline thermoplastic resin, where the bonding material has a melting temperature lower than the melting temperature of the crystalline thermoplastic resin and a softening temperature higher than the softening temperature of the amorphous thermoplastic resin.

The present disclosure is not limited to the above-described embodiments, and various modifications can further be made. For example, the present disclosure includes structures substantially the same as the structures described in the embodiments (structures having the same functions, methods, and results as those of the present disclosure or structures intended to achieve the same objects as those of the present disclosure and having the same effects). The present disclosure includes structures in which the non-essential portions of the structures described in the embodiments are substituted. The present disclosure includes structures having the same working effects as those of the structures described in the embodiments or structures configured to achieve the same objects as those of the structures described in the embodiments. The present disclosure includes structures in which publicly known techniques are added to the structures described in the embodiments.

What is claimed is:

1. A bonding material for fiber binding, comprising:
a resin composition containing
an amorphous thermoplastic resin and
a crystalline thermoplastic resin, wherein the bonding material has
a melting temperature lower than a melting temperature of the crystalline thermoplastic resin and
a softening temperature higher than a softening temperature of the amorphous thermoplastic resin.

2. The bonding material according to claim 1, wherein
the bonding material is a powder, and
a content of the crystalline thermoplastic resin with respect to a total amount of the resin composition is 10% by mass or more and 30% by mass or less.

3. A fiber molded article, comprising:
the bonding material for fiber binding according to claim 1 and
a plurality of fibers, wherein
the plurality of fibers are bound by the bonding material.

4. A method for manufacturing a bonding material for fiber binding, comprising:
a kneading step of performing melt-kneading of an amorphous thermoplastic resin and a crystalline thermoplastic resin to form a resin composition;
a pelletizing step of pelletizing the resin composition; and
a pulverizing step of pulverizing the resin composition pelletized.

5. The method for manufacturing a bonding material according to claim 4, wherein,
in the kneading step, the melt-kneading is performed such that a content of the crystalline thermoplastic resin with respect to a total amount of the resin composition is 10% by mass or more and 30% by mass or less.

6. A method for manufacturing a fiber molded article, comprising:
a mixing step of mixing the bonding material for fiber binding according to claim 1 and a fiber;
an accumulating step of accumulating the fiber and the bonding material in a mixture; and
a binding step of binding the fiber and the bonding material in the mixture, the fiber and the bonding material in the mixture being an accumulation accumulated.
